(19) United States
(12) Patent Application Publication
(10) Pub. No.: US 2020/0384743 A1
(43) Pub. Date: Dec. 10, 2020

(54) LAMINATE, MOLDED ARTICLE AND METHOD FOR PRODUCING SAME

(71) Applicant: DAICEL CORPORATION, Osaka-shi, Osaka (JP)

(72) Inventors: Daisuke USA, Tokyo (JP); Hiroshi TAKAHASHI, Tokyo (JP)

(73) Assignee: DAICEL CORPORATION, Osaka-shi, Osaka (JP)

(21) Appl. No.: 16/767,694

(22) PCT Filed: Oct. 16, 2018
(86) PCT No.: PCT/JP2018/038399

§ 371 Date: May 28, 2020

(30) Foreign Application Priority Data
Feb. 21, 2018 (JP) 2018-029122

(51) Int. Cl. B32B 27/08; B32B 7/022; C08G 18/67; C08J 7/04; B29C 45/14

(52) U.S. Cl. CPC B32B 27/08; B32B 7/022; B29C 45/14; C08J 7/04; C08G 18/672

(57) ABSTRACT

Provided is a laminate that includes a hard coat layer laminated on at least one surface of a substrate layer. The laminate has a tensile elongation in accordance with JIS K6251 of 5% or greater, and exhibits no scratch after reciprocating sliding of a #0000 steel wool 1000 times on a surface of the hard coat layer under a load of 1 kg/cm². The pencil hardness of the hard coat layer may be F or higher. The haze of the laminate may be 2% or less. The total light transmittance of the laminate may be 85% or higher. The hard coat layer may be formed from a cured product of a curable composition that includes a polyfunctional (meth)acrylate and a fluorine-containing vinyl compound. The polyfunctional (meth)acrylate may include a urethane (meth)acrylate and a (meth)acrylate of a polyhydric alcohol-alkylene oxide adduct. The laminate can provide both scratch resistance and stretching characteristics.

### TECHNICAL FIELD

The present invention relates to a stretchable hard coat film (laminate) in which crack generation and the like are suppressed even when subjected to molding requiring flexibility such as in-mold molding, and also relates to a molded article containing the film, and a method for producing the same.

### BACKGROUND ART

Molded articles formed from polyester or other such thermoplastic resins exhibit excellent moldability and mechanical properties, and therefore are used in various applications. However, compared to inorganic materials such as glass, the hardness of the surface is low, and the surface may be scratched easily, and therefore, in some applications, a curable resin such as a photocurable resin is applied to the surface and cured to form a hard coat layer having high hardness. Such hard coat layers are used in various applications in the field of molded articles formed from thermoplastic resins, and examples of such molded articles include optical equipment, precision equipment, electrical and electronic equipment, and everyday commodities. The hard coat layer is often used in the form of a hard coat film laminated on a substrate film.

JP 2017-132833 (Patent Document 1) discloses a hard coat film in which a cured resin layer of a UV curable resin composition containing a polyfunctional (meth)acrylate, (meth)acrylic group-modified metal oxide particles, and a photopolymerization initiator, is formed on a plastic film. In addition, JP 2017-152004 (Patent Document 2) discloses a protective film for a touch panel, the protective film being provided with: on one surface of a substrate film, a UV curable resin layer in which a UV curable resin composition containing a polymerizable fluorine compound and a polyfunctional urethane (meth)acrylate compound is cured; and on the other surface of the substrate, a hard coat layer containing particles.

However, while scratch resistance is exhibited in these hard coat films, the stretching characteristics (flexibility) is low and applications are limited. For example, with hard coat films that are used for in-mold molding, stretching characteristics is required to a degree such that the hard coat film is compliant to the shape of the mold. However, with these hard coat films, the stretching characteristics is poor, and cracking occurs during in-mold molding.

JP 2016-180082 (Patent Document 3) discloses, as a hard coat film that is not only scratch resistant but also develops no cracking even when elongated, a laminated film having a film for molding that is formed on at least one surface of a resin film and is made from a hard coating agent for decorative molding, the hard coating agent containing a (meth)acrylic-based polymer having an imide ring.

However, because the scratch resistance and stretching characteristics are in a trade-off relationship, it is difficult to achieve a sufficiently good stretching characteristics while maintaining scratch resistance, and even with a hard coat film in which this hard coating agent for decorative molding is used, it has been difficult to achieve both scratch resistance and stretching characteristics simultaneously. For example, the method of Patent Document 3 is method known as “pre-curing” in which a film is cured when it is produced, after which a user who has purchased the film subjects the film to molding. With this method, a relatively good hardness, which is approximately a pencil hardness of from H to 2H, can be achieved, and scratch resistance can be imparted to the film. However, it is difficult to improve the stretching characteristics, and moldability is poor. Therefore, the pre-curing method is not attracting attention or being employed in fields requiring moldability. On the other hand, a method referred to as “after curing” is also known as a method that uses a molding film, and with this method, the film is cured after molding, and therefore stretching characteristics and the degree of molding freedom are both good. However, with the after curing method, the pencil hardness can only be improved to approximately F, and the film is not scratch resistant, and therefore this method is not employed in fields requiring scratch resistance. The difficulty of achieving both scratch resistance and stretching characteristics can be understood from such current conditions.

### CITATION LIST

### Patent Documents

Patent Document 1: JP 2017-132833 A (claims 1 and 7)

Patent Document 2: JP 2017-152004 A (claims)

Patent Document 3: JP 2016-180082 A (claims, paragraph [0005])

### SUMMARY OF INVENTION

### Technical Problem

Therefore, an object of the present invention is to provide a laminate that can provide both scratch resistance and stretching characteristics (or compliance), a molded article containing the laminate, and a method for producing the same.

Another object of the present invention is to provide a highly transparent laminate that can suppress the occurrence of cracking even when molded with a method that requires bending, such as in-mold molding, and to provide a molded article containing this laminate and a method for producing the same.

### Solution to Problem

As a result of diligent research to solve the aforementioned problems, the present inventors discovered that a novel hard coat film (laminate or laminated film) that provides both scratch resistance and stretching characteristics. The novel hard coat film can be obtained by laminating on one surface of a substrate layer, a hard coat layer formed of a cured product of a specific curable composition, and thus the present inventors completed the present invention.

That is, a laminate of the present invention has a hard coat layer laminated on at least one surface of a substrate layer, wherein the laminate has a tensile elongation in accordance with JIS K6251 of 5% or greater, and exhibits no scratch after reciprocating sliding of a #0000 steel wool 1000 times on a surface of the hard coat layer under a load of 1 kg/cm². The pencil hardness of the hard coat layer may be F or higher. The haze of the laminate may be 2% or less. The total light transmittance of the laminate may be 85% or greater. The hard coat layer may be formed from a cured product of a curable composition containing a fluorine-free vinyl compound. The fluorine-free vinyl compound may include a polyfunctional (meth)acrylate. The polyfunctional (meth)acrylate may contain urethane (meth)acrylate (in particular, trifunctional or higher urethane (meth)acrylate having a weight average molecular weight of 3000 or less). The polyfunctional (meth)acrylate may contain a (meth)acrylate of a polyhydric alcohol-alkylene oxide adduct. The polyhydric alcohol may be a trihydric or higher polyhydric alcohol. The total number of moles of the alkylene oxide added may be from 2 to 30 moles. The polyhydric alcohol-alkylene oxide adduct may be an adduct in which from 1 to 3 moles of ethylene oxide are added to each hydroxyl group of a tetrahydric to octahydric alcohol. The curable composition may further contain a fluorine-containing vinyl compound. A weight ratio of the urethane (meth)acrylate to the (meth)acrylate of the polyhydric alcohol-alkylene oxide adduct, [the urethane (meth)acrylate]/[the (meth)acrylate of the polyhydric alcohol-alkylene oxide adduct], may be from 80/20 to 30/70. A ratio of the fluorine-containing vinyl compound may be from 0.1 to 10 parts by weight per 100 parts by weight of the fluorine-free vinyl compound.

The present invention also includes a molded article that includes the laminate. At least a portion of the laminate may be curved or bent. The present invention also includes a method for producing a molded article by molding the laminate. In this method, the molded article may be produced by in-mold molding.

### Advantageous Effects of Invention

In the present invention, the laminate on which a hard coat layer is laminated has a tensile elongation of 5% or greater, and the laminate exhibits no scratch after reciprocating sliding of a #0000 steel wool 1000 times on a surface of the hard coat layer under a load of 1 kg/cm², and thus scratch resistance and stretching characteristics (or compliance) can both be achieved. Therefore, cracks can be suppressed even when the laminate is molded with a method that requires bending, such as in-mold molding. Furthermore, transparency can be improved when a resin film is formed from a transparent plastic and the hard coat layer is formed from a transparent cured product.

### DESCRIPTION OF EMBODIMENT

### Hard Coat Layer

The laminate according to an embodiment of the present invention is a laminate in which a hard coat layer is laminated on at least one surface of a substrate layer. The hard coat layer excels in scratch resistance, and preferably exhibits no scratch (e.g., a line scratch) on the surface after reciprocating sliding (at a velocity of 10 cm/s) of a #0000 steel wool 1000 times on a surface of the hard coat layer under a load of 1 kg/cm² at room temperature (approximately 20 to 25° C., for example, 23° C.), and preferably exhibits no change (e.g., color change due to slight surface shaving). Note that in the present specification and the claims, the scratch resistance can be evaluated by a method described in the examples described below, and a determination of scratches is made by evaluation through visual observation.

The hard coat layer has a high surface hardness, and may have a pencil hardness (at 750 g load) in accordance with JIS K5600 of F or higher (e.g., from F to 5H), and the pencil hardness is preferably H or higher (e.g., from H to 4H), and is even more preferably 2H or higher (e.g., from 2H to 3H).

The hard coat layer exhibits a good sliding characteristics, and the water contact angle may be 85° or greater, for example, from 85 to 120°, and is preferably approximately from 90 to 115°, and even more preferably approximately from 95 to 112° (in particular, from 100 to 110°). If the water contact angle is too small, probably due to poor sliding characteristics, scratch resistance may decline. Note that in the present specification and claims, the water contact angle can be measured using an automatic dynamic contact angle gauge, and more specifically, can be measured by the method described in the examples below.

The material of the hard coat layer is not particularly limited as long as the hard coat layer exhibits sufficient scratch resistance, and satisfies the matter of having a tensile elongation of the laminate described below of 5% or greater, but ordinarily, the hard coat layer is formed from a cured product of a curable composition containing a fluorine-free vinyl compound.

### Fluorine-Free Vinyl Compound

Examples of the fluorine-free vinyl compound include monofunctional vinyl compounds [(meth)acrylic monomers such as (meth)acrylates, isobornyl (meth)acrylates, and adamantyl (meth)acrylates; vinyl monomers such as vinyl pyrrolidone; aromatic vinyl monomers such as styrene, and the like] and polyfunctional vinyl compounds [such as polyfunctional (meth)acrylates]. These vinyl compounds can be used alone or in a combination of two or more. Of these, from the perspective of scratch resistance, polyfunctional (meth)acrylates are typically used in the hard coat layer.

The polyfunctional (meth)acrylate includes monomers and oligomers [or a resin (in particular, a low molecular weight resin)]. Further, the monomers can be broadly divided into bifunctional (meth)acrylate monomers and trifunctional or higher polyfunctional (meth)acrylate monomers.

Examples of bifunctional (meth)acrylate monomers include alkylene glycol di(meth)acrylates such as ethylene glycol di(meth)acrylate, propylene glycol di(meth)acrylate, butanediol di(meth)acrylate, neopentyl glycol di(meth)acrylate, and hexanediol di(meth)acrylate; polyoxyalkylene glycol di(meth)acrylates such as diethylene glycol di(meth)acrylate, dipropylene glycol di(meth)acrylate, and polyoxytetramethylene glycol di(meth)acrylate; and di(meth)acrylates having a bridged cyclic hydrocarbon group such as tricyclodecane dimethanol di(meth)acrylate, and adamantane di(meth)acrylate. These bifunctional (meth)acrylate monomers can be used alone or in a combination of two or more.

Examples of trifunctional or higher polyfunctional (meth)acrylate monomers include polyfunctional (meth)acrylates with a functional degree of approximately from 3 to 10, including (meth)acrylates of polyhydric alcohols such as glycerin tri(meth)acrylate, trimethylolethane tri(meth)acrylate, trimethylolpropane tri(meth)acrylate, pentaerythritol tri(meth)acrylate, ditrimethylolpropane tetra(meth)acrylate, pentaerythritol tetra(meth)acrylate, dipentaerythritol penta(meth)acrylate, and dipentaerythritol hexa(meth)acrylate; and (meth)acrylates of polyhydric alcohol-alkylene oxide adducts corresponding to these esters. These polyfunctional (meth)acrylates can be used alone or in a combination of two or more.

Examples of the oligomer or resin include a (meth)acrylate of a bisphenol A-alkylene oxide adduct, epoxy (meth)acrylates [such as bisphenol A type-epoxy (meth)acrylate and novolac-type epoxy (meth)acrylate], polyester (meth)acrylates [such as, for example, aliphatic polyester-type (meth)acrylates and aromatic polyester-type (meth)acrylates], (poly)urethane (meth)acrylates, and silicone (meth)acrylates. These oligomers and resins can be used alone or in a combination of two or more types.

Of these, from the perspective of achieving both scratch resistance and stretching characteristics, an alkylene glycol di(meth)acrylate, a (meth)acrylate of a polyhydric alcohol-alkylene oxide adduct [hereinafter, referred to as an “AO-modified polyhydric alcohol (meth)acrylate”], and a urethane (meth)acrylate are preferable.

### (A) Alkylene Glycol Di(Meth)Acrylate

Examples of the alkylene glycol di(meth)acrylate include C₂₋₁₂ alkylene glycol di(meth)acrylates such as butanediol di(meth)acrylate, neopentyl glycol di(meth)acrylate, hexanediol di(meth)acrylate, octanediol di(meth)acrylate, and decanediol di(meth)acrylate. These alkylene glycol di(meth)acrylates can be used alone or in a combination of two or more. Of these, C₄₋₈ alkylene glycol di(meth)acrylates such as hexanediol di(meth)acrylate are preferred.

### (B) AO-Modified Polyhydric Alcohol (Meth)Acrylate

In the AO-modified polyhydric alcohol (meth)acrylate, the hydric number (number of hydroxyl groups) of the polyhydric alcohol is not particularly limited, and the polyhydric alcohol may be dihydric or higher, but is preferably at least trihydric from the perspective of improving scratch resistance. Furthermore, from the perspectives of scratch resistance and stretching characteristics, the hydric number of the polyhydric alcohol is, for example, approximately from 3 to 10, preferably from 3 to 9, and more preferably from 4 to 8 (particularly, from 5 to 7).

Examples of polyhydric alcohols include glycerin, trimethylolethane, trimethylolpropane, pentaerythritol, diglycerin, ditrimethylolpropane, pentaerythritol, and dipentaerythritol. These polyhydric alcohols can also be used alone or in a combination of two or more types. Of these, tetrahydric to octahydric alcohols (in particular, pentahydric to heptahydric alcohols) such as dipentaerythritol are preferred.

The number of moles of alkylene oxide added is not particularly limited, and it is sufficient that one or more alkylene oxides are added to at least one hydroxyl group of the polyhydric alcohol, and the number of moles of alkylene oxide added to each hydroxyl group may be the same or different, but the same is preferable. The total number of moles of alkylene oxide added per 1 mole of the polyhydric alcohol may be 1 mole or greater, and can be selected according to the hydric number of the polyhydric alcohol. For example, the total number of moles of alkylene oxide added may be approximately from 2 to 30 moles, preferably from 3 to 25 moles (for example, from 5 to 20 moles), and even more preferably approximately from 8 to 15 moles (in particular, from 10 to 13 moles). The average number of moles of alkylene oxide added per each hydroxyl group of the polyhydric alcohol can be selected from a range of about 0.1 to 10 moles, and may be, for example from 0.3 to 5 moles, preferably from 0.5 to 3 moles, and more preferably from 0.8 to 2 moles (in particular, from 1 to 1.5 moles), and may be 1 mole. If the number of moles of alkylene oxide added is too small, the stretching characteristics may decrease, and if the number is too large, scratch resistance may decrease.

From the perspectives of enhancing the mechanical properties of the laminate and excelling in procurement ease, from 1 to 3 moles of alkylene oxide may be added to each hydroxyl group of the polyhydric alcohol, and in particular, an adduct in which 2 moles of ethylene oxide are added to each hydroxyl group of a trihydric or higher polyhydric alcohol may be used.

Examples of the alkylene oxide include C₂₋₆ alkylene oxides such as ethylene oxide, propylene oxide, butylene oxide, and tetrahydrofuran. These alkylene oxides can be used alone or in a combination of two or more. Of these, C₂₋₄ alkylene oxides such as ethylene oxide and propylene oxide are preferable, and C₂₋₃ alkylene oxides (especially ethylene oxide) are particularly preferred.

The weight average molecular weight of the AO-modified polyhydric alcohol (meth)acrylate is not particularly limited, and determined by gel permeation chromatography (GPC) calibrated with polystyrene. The weight average molecular weight of the AO-modified polyhydric alcohol (meth)acrylate may be 5000 or less (for example, from 500 to 5000), and for example, may be approximately from 550 to 3000, preferably from 600 to 2000, and more preferably from 800 to 1500 (in particular, from 1000 to 1200). If the molecular weight is too small, the stretching characteristics may decrease, and if the molecular weight is too large, scratch resistance may be reduced.

(C) Urethane (meth)acrylate

The urethane (meth)acrylate may be a urethane (meth)acrylate that is obtained by reacting a (meth)acrylate having an active hydrogen atom with polyisocyanates.

The polyisocyanates may be a urethane prepolymer that has a free isocyanate group and is produced through a reaction between a polyisocyanate and a polyol (such as, for example, polyester polyester and polyether polyester), and the polyisocyanates are preferably a polyisocyanate from the perspective of scratch resistance.

Examples of the polyisocyanate include aliphatic polyisocyanates, alicyclic polyisocyanates, aromatic aliphatic polyisocyanates, aromatic polyisocyanates, and derivatives of polyisocyanates.

Examples of aliphatic polyisocyanates include C₂₋₁₆ alkane-diisocyanates such as tetramethylene diisocyanate, hexamethylene diisocyanate (HDI), and trimethyl hexamethylene diisocyanate. Examples of the alicyclic polyisocyanates include 1,4-cyclohexane diisocyanate, isophorone diisocyanate (IPDI), 4,4′-methylene bis(cyclohexyl isocyanate), hydrogenated xylylene diisocyanate, and norbornane diisocyanate. Examples of the aromatic aliphatic polyisocyanates include xylylene diisocyanate (XDI) and tetramethylxylylene diisocyanate. Examples of aromatic polyisocyanates include phenylene diisocyanate, 1,5-naphthalene diisocyanate (NDI), diphenylmethane diisocyanate (MDI), tolylene diisocyanate (TDI), 4,4′-toluidine diisocyanate, and 4,4′-diphenylether diisocyanate. Examples of derivatives of the polyisocyanates include multimers such as dimers and trimers, biurets, allophanates, carbodiimides, and uretdiones. These polyisocyanates can be used alone or in a combination of two or more.

From the perspectives of being able to achieve both scratch resistance and stretching characteristics and being suited also for optical applications, of these polyisocyanates, non-yellowing type diisocyanates or derivatives thereof, including for example HDI and other such aliphatic diisocyanates, IPDI, hydrogenated XDI and other alicyclic diisocyanates, are preferable, and C₄₋₁₂ alkane-diisocyanates (especially C₅₋₈ alkane-diisocyanates) including HDI are particularly preferable.

Examples of (meth)acrylates having an active hydrogen atom include hydroxy C₂₋₆ alkyl (meth)acrylates such as 2-hydroxyethyl (meth)acrylate, and 2-hydroxypropyl (meth)acrylate; hydroxyalkoxy C₂₋₆ alkyl (meth)acrylates such as 2-hydroxy-3-methoxypropyl (meth)acrylate; and (meth)acrylic acid partial esters of polyhydric alcohols such as ditrimethylol ethane tri(meth)acrylate, ditrimethylol propane tri(meth)acrylate, pentaerythritol tri(meth)acrylate, and dipentaerythritol penta(meth)acrylate. These (meth)acrylates can be used alone or in a combination of two or more. Of these, from the perspective of scratch resistance, a (meth)acrylic acid partial ester of a polyhydric alcohol such as pentaerythritol tri(meth)acrylate is preferable.

The number of (meth)acryloyl groups (number of functional groups) per molecule of the urethane (meth)acrylate may be two or more (two or more functional groups), and is approximately, for example, from 2 to 20, preferably from 3 to 15 (for example, from 4 to 10), and even more preferably from 4 to 8 (in particular, from 5 to 7). If the number of (meth)acryloyl groups is too small, scratch resistance may decrease, and if the number is too large, the stretching characteristics may decline.

The weight average molecular weight of the urethane (meth)acrylate is not particularly limited, and determined by gel permeation chromatography (GPC) calibrated with polystyrene. The weight average molecular weight of the urethane (meth)acrylate may be 3000 or less (for example, from 500 to 3000), and for example, may be approximately from 550 to 2000, preferably from 600 to 1500, and more preferably from 650 to 1000 (in particular, from 700 to 800). If the molecular weight is too small, the stretching characteristics may decrease, and if the molecular weight is too large, scratch resistance may be reduced.

### (D) Aspects of Combinations

Even among these fluorine-free vinyl compounds, preferably, at least a urethane (meth)acrylate is included to achieve both scratch resistance and stretching characteristics, and a combination of a urethane (meth)acrylate and a urethane-free (meth)acrylate [alkylene glycol di(meth)acrylate and/or

AO-modified polyhydric alcohol (meth)acrylate] is particularly preferable. Furthermore, to achieve excellent performance on both properties, a combination of a tri-functional or higher urethane (meth)acrylate having a weight average molecular weight of 3000 or less and an AO-modified polyhydric alcohol (meth)acrylate (in particular, an adduct in which from 1 to 3 moles of ethylene oxide are added to each hydroxyl group of a tetrahydric to octahydric alcohol) is most preferable.

The weight ratio of the urethane (meth)acrylate [in particular, a trifunctional or higher urethane (meth)acrylate having a weight average molecular weight of 3000 or less] to the urethane-free (meth)acrylate [in particular, the AO-modified polyhydric alcohol (meth)acrylate], [the urethane (meth)acrylate]/[the urethane-free (meth)acrylate], can be selected from a range of approximately from 90/10 to 3/97, and may be approximately, for example, from 80/20 to 5/95 (for example, from 70/30 to 10/90), preferably from 50/50 to 15/85, and even more preferably from 40/60 to 20/80 (in particular, from 35/65 to 25/75), and from the perspectives of being able to improve stretching characteristics and to maintain the pencil hardness at H or higher at which hard coating properties are favorable, the weight ratio thereof may be in a range of approximately from 80/20 to 30/70. If the ratio of the urethane (meth)acrylate is too low, scratch resistance and surface hardness may decrease, and conversely, if the ratio is too large, stretching characteristics may decrease.

### Fluorine-Containing Vinyl Compound

From the perspective of improving scratch resistance, the curable composition preferably further includes a fluorine-containing vinyl compound in addition to the fluorine-free vinyl compound.

The fluorine-containing vinyl compound may be a fluoride of the fluorine-free vinyl compound. Examples of the fluorine-containing vinyl compound include fluorinated alkyl (meth)acrylates [such as, for example, perfluorooctylethyl (meth)acrylate and trifluoroethyl (meth)acrylate], and fluorinated (poly)oxyalkylene glycol di(meth)acrylate [such as, for example, fluoroethylene glycol di(meth)acrylate, fluoropolyethylene glycol di(meth)acrylate, and fluoropropylene glycol di(meth)acrylate]. These fluorine-containing vinyl compounds can be used alone or in combination of two or more.

Among those, a fluoropolyether compound having a (meth)acryloyl group is preferred. The fluorine-containing vinyl compound may be a commercially available fluorine-based polymerizable leveling agent.

The ratio of the fluorine-containing vinyl compound is, per 100 parts by weight of the fluorine-free vinyl compound, approximately from 0.1 to 10 parts by weight (for example, from 0.2 to 8 parts by weight), preferably from 0.3 to 5 parts by weight (for example, from 0.5 to 3 parts by weight), and even more preferably from 0.8 to 2 parts by weight (in particular, from 1 to 1.5 parts by weight). If the ratio of the fluorine-containing vinyl compound is too small, the effect of improving scratch resistance may decrease, and conversely, if the ratio is too large, the scratch resistance and surface hardness may decrease.

### Thermoplastic Resin

The curable composition may further contain a thermoplastic resin from the perspective of improving properties such as film formability of the hard coat layer.

Examples of the thermoplastic resin include a styrene-based resin, a (meth)acrylic-based polymer, an organic acid vinyl ester polymer, a vinyl ether-based polymer, a halogen-containing resin, a polyolefin (including alicyclic polyolefin), polycarbonate, polyester, polyamide, thermoplastic polyurethane, a polysulfone-based resin (such as polyether sulfone and polysulfone), a polyphenylene ether-based resin (such as a polymer of 2,6-xylenol), a cellulose derivative (such as cellulose esters, cellulose carbamates, and cellulose ethers), a silicone resin (such as polydimethylsiloxane and polymethylphenylsiloxane), and a rubber or elastomer (diene rubbers such as polybutadiene and polyisoprene, a styrene-butadiene copolymer, an acrylonitrile-butadiene copolymer, acrylic rubber, urethane rubber, and silicone rubber). These thermoplastic resins can be used alone or in a combination of two or more.

From the perspective of excelling in transparency when used in applications such as an optical application, of these thermoplastic resins, styrene-based resins, (meth)acrylic-based polymers, vinyl acetate-based polymers, vinyl ether-based polymers, halogen-containing resins, alicyclic polyolefins, polycarbonates, polyesters, polyamides, cellulose derivatives, silicone-based resins, and rubbers or elastomers are generally used, and cellulose esters are preferable.

Examples of the cellulose esters include aliphatic organic acid esters (cellulose acetates such as cellulose diacetate and cellulose triacetate; and C₁₋₆ aliphatic carboxylates such as cellulose propionate, cellulose butyrate, cellulose acetate propionate, and cellulose acetate butyrate), aromatic organic acid esters (C₇₋₁₂ aromatic carboxylates such as cellulose phthalate and cellulose benzoate), and inorganic acid esters (such as, for example, cellulose phosphate and cellulose sulfate), and the cellulose esters may be mixed acid esters such as an acetic acid-nitric acid cellulose ester. These cellulose esters can be used alone or in a combination of two or more. Among these, cellulose C₂₋₄ acylates such as cellulose diacetate, cellulose triacetate, cellulose acetate propionate, and cellulose acetate butyrates are preferable, and cellulose acetate C₃₋₄ acylates such as cellulose acetate propionate are particularly preferable.

The ratio of the thermoplastic resin (in particular, a cellulose ester) is approximately, for example, from 0.05 to 10 parts by weight, preferably from 0.1 to 5 parts by weight (for example, from 0.3 to 3 parts by weight), and more preferably from 0.5 to 2 parts by weight (particularly, from 0.8 to 1.5 parts by weight), per 100 parts by weight of the fluorine-free vinyl compound. If the ratio of the thermoplastic resin is too low, the effect of improving film formability may be reduced, and conversely, if the ratio is too large, scratch resistance may decline.

### Filler

The curable composition may further contain a filler from the perspective of improving scratch resistance and surface hardness.

The filler may contain, for example, inorganic particles such as silica particles, titania particles, zirconia particles, and alumina particles, and organic particles such as crosslinked (meth)acrylic-based polymer particles, and crosslinked styrene-based resin particles. These fillers can be used alone or in a combination of two or more.

Among these fillers, when used in an optical application, nanometer-sized silica particles (silica nanoparticles) are preferable from the perspective of excelling in transparency. The silica nanoparticles are preferably solid silica nanoparticles from the perspective of being able to suppress yellowness of the laminate. In addition, an average particle diameter of the silica nanoparticles is, for example, from about 1 to 800 nm, preferably from about 3 to 500 nm, and more preferably from about 5 to 300 nm.

The ratio of the filler (in particular, silica nanoparticles) is approximately, for example, from 1 to 200 parts by weight, preferably from 5 to 150 parts by weight, and more preferably from 10 to 100 parts by weight (particularly from 20 to 80 parts by weight) per 100 parts by weight of the fluorine-free vinyl compound. If the ratio of the filler is too low, the effect of improving matters such as scratch resistance and surface hardness may decrease, and conversely, if the ratio is too large, the stretching characteristics may decrease.

### Curing Agent

The curable composition may further contain a curing agent depending on the type of the curable composition. For example, a thermal curable composition may contain curing agents such as amines and polyhydric carboxylic acids, and a photocurable composition may contain a photopolymerization initiator and/or a photocuring accelerator. Examples of the photopolymerization initiator include commonly used components such as acetophenones or propiophenones, benzyls, benzoins, benzophenones, thioxanthones, and acylphosphine oxides. Examples of the photocuring accelerator include tertiary amines (such as a dialkylaminobenzoate), and a phosphine-based photopolymerization accelerator. The ratio of the curing agent is approximately, for example, from 0.1 to 20 parts by weight, preferably from 0.5 to 10 parts by weight, and more preferably from 1 to 5 parts by weight per 100 parts by weight of the fluorine-free vinyl compound.

### Commonly Used Additives

The curable composition may further contain commonly used additives. Commonly used additives include, for example, other curable resins (such as fluorine-containing epoxy resins and fluorine-containing urethane resins), leveling agents (excluding fluorine-containing vinyl compounds), stabilizers (such as antioxidants and UV absorbers), surfactants, water-soluble polymers, fillers, crosslinking agents, coupling agents, colorants, flame retardants, lubricants, waxes, preservatives, viscosity modifiers, thickeners, and antifoaming agents. The total ratio of commonly used additives per 100 parts by weight of the fluorine-free vinyl compound is approximately, for example, from 0.01 to 10 parts by weight (in particular, from 0.1 to 5 parts by weight).

### Properties of the Hard Coat Layer

When the hard coat layer is formed from a cured product of the curable composition, as described above, it is particularly preferable to include an AO-modified polyhydric alcohol (meth)acrylate in addition to the urethane (meth)acrylate. By including, at a predetermined ratio, an ether bond derived from an oxyalkylene group by the AO-modified material, a balance between scratch resistance and stretching characteristics of the hard coat layer can be obtained. The presence or absence of ether bonds can be easily determined from the observance of absorption of antisymmetric stretching of the ether bond (C—O—C) in a range of from 1150 to 1080 cm⁻¹ (near 1100 cm⁻¹ as an absorption peak) in the infrared spectrum. The ratio of oxyalkylene units in the cured product is approximately, for example, from 2 to 50 wt. %, preferably from 4 to 30 wt. %, and even more preferably from 5 to 20 wt. %. If the ratio of the oxyalkylene units is too small, stretching characteristics may decrease, and conversely if the ratio is too large, scratch resistance may decrease.

The hard coat layer may be laminated on both sides of the substrate layer, but is normally laminated to only one side. The thickness (average thickness) of the hard coat layer formed on one surface of the substrate layer is approximately, for example, from 0.3 to 20 μm, preferably from 1 to 15 μm, and even more preferably from 2 to 10 μm (for example, from 3 to 8 μm).

### Substrate Layer

The substrate layer is not particularly limited as long as the substrate layer can satisfy that the laminate has a tensile elongation of 5% or greater as described below, and the substrate layer may be formed from an inorganic material such as ceramic or metal, but preferably from organic materials from the perspective of good stretching characteristics and moldability.

The organic material may be a curable resin, but a thermoplastic resin is preferable from the perspective of excelling in stretching characteristics and moldability. Examples of the thermoplastic resin include cellulose derivatives, polyesters, polyamides, polyimides, polycarbonates, (meth)acrylic-based polymers, polyolefins, polyurethanes, acrylonitrile-styrene copolymers (AS resins), and acrylonitrile-butadiene-styrene copolymers (ABS resins). For optical applications and decorative applications in which printing is applied to the back surface of the substrate to impart a design property or the like, the substrate layer is preferably transparent, and for example, has a haze (turbidity) of not greater than 10%, and a total light transmittance of 85% or greater. Of these, cellulose esters, polyesters, and the like that have a haze (turbidity) of 2% or less and a total light transmittance of 89% or greater are generally used from the perspective of achieving excellent transparency when the substrate is used in an optical application or the like.

Examples of cellulose esters include cellulose acetate such as cellulose triacetate (TAC), and cellulose acetate C₃₋₄ acylate such as cellulose acetate propionate and cellulose acetate butyrate. Examples of the polyester include polyalkylenearylates such as polyethylene terephthalate (PET) and polyethylene naphthalate (PEN).

Among these, poly C₂₋₄ alkylene arylates such as PET and PEN are preferred from the perspective of achieving an excellent balance between properties such as mechanical properties and transparency.

The substrate layer may also contain commonly used additives given as examples in the section on the hard coat layer. The ratio of the additives is the same as that for the hard coat layer.

The substrate layer may be a uniaxially or biaxially stretched film, but may also be an unstretched film from the perspective of good optical isotropy.

The substrate layer may be subjected to a surface treatment (such as, for example, a corona discharge treatment, a flame treatment, a plasma treatment, and an ozone or ultraviolet irradiation treatment), and may have an easily adhesive layer.

The thickness (average thickness) of the substrate layer may be adjusted depending on the material, as long as the substrate layer thickness can satisfy that the laminate has the tensile elongation of 5% or greater as described below. For the plastic film such as a PET film, the thickness is approximately, for example, from 5 to 2000 μm (for example, from 10 to 1000 μm), preferably from 15 to 500 μm (for example, from 20 to 300 μm), and even more preferably from 20 to 200 μm.

### Laminate

The laminate according to an embodiment of the present invention has a scratch-resistant hard coat layer laminated on at least one surface (in particular, one side) of the substrate layer, and not only has good scratch resistance, but also has good stretching characteristics. The laminate according to an embodiment of the present invention has a tensile elongation in accordance with JIS K6251 of 5% or greater (for example, from 5 to 20%), preferably 6% or greater (for example, from 6 to 15%), more preferably 7% or greater (for example, from 7 to 13%), and most preferably 8% or greater (for example, from 8 to 12%). Note that in the present specification and claims, the tensile elongation can be measured by a method according to JIS K6251, and more specifically, can be measured by a method described in the examples below.

In the laminate according to an embodiment of the present invention, the hard coat layer exhibits excellent transparency, and forming the substrate layer from a transparent material can further improve transparency. Thus, the total light transmittance of the laminate according to an embodiment of the present invention may be 70% or greater, and is preferably 85% or greater (for example, from 85% to 99%), more preferably 88% or greater (for example, from 88 to 98%), and most preferably 90% or greater (for example, from 90 to 95%). Furthermore, the laminate according to an embodiment of the present invention may have a haze of 5% or less, preferably 3% or less (for example, from 0.1 to 3%), more preferably 2% or less (for example, from 0.2 to 2%), and most preferably 1.5% or less (for example, from 0.3 to 1.5%).

In the present specification and claims, the haze and total light transmittance can be measured according to JIS K7136 and JIS K7361, respectively, using a haze meter (“NDH-5000W” available from Nippon Denshoku Industries Co., Ltd.).

The method for producing the laminate according to an embodiment of the present invention is not particularly limited, and the laminate can be produced by a commonly used method depending on the type of the hard coat layer. For example, a laminate, in which the hard coat layer is formed from a cured product of a curable composition, may be produced by a method including applying a liquid curable composition to a substrate layer and drying the curable composition, and then curing the dried curable composition by heat or active energy rays.

The liquid curable composition may further contain a solvent in addition to the fluorine-free vinyl compound and other such components. Examples of such solvents include ketones (such as acetone, methyl ethyl ketone, methyl isobutyl ketone, and cyclohexanone), ethers (such as dioxane and tetrahydrofuran), aliphatic hydrocarbons (such as hexane), alicyclic hydrocarbons (such as cyclohexane), aromatic hydrocarbons (such as toluene and xylene), halogenated hydrocarbons (such as dichloromethane and dichloroethane), esters (such as methyl acetate, ethyl acetate, and butyl acetate), water, alcohols (such as ethanol, isopropanol, butanol, and cyclohexanol), cellosolves [such as methyl cellosolve, ethyl cellosolve, and propylene glycol monomethyl ether (1-methoxy-2-propanol)], cellosolve acetates, sulfoxides (such as dimethyl sulfoxide), and amides (such as dimethylformamide and dimethylacetamide). In addition, the solvent may be a mixed solvent.

Among these solvents, the curable composition preferably contains ketones such as methyl ethyl ketone, and a mixed solvent of ketones with alcohols (such as butanol) and/or cellosolves (such as 1-methoxy-2-propanol) is particularly preferable. In the mixed solvent, the ratio of alcohols and/or cellosolves (total amount when the both are mixed) is approximately, for example, from 10 to 150 parts by weight, preferably from 15 to 100 parts by weight, and more preferably from 20 to 80 parts by weight (in particular, from 30 to 50 parts by weight) per 100 parts by weight of the ketones. For a case in which alcohols and cellosolves are combined, the ratio of the cellosolves per 100 parts by weight of the alcohols is approximately, for example, from 30 to 300 parts by weight, preferably from 40 to 200 parts by weight, and more preferably from 50 to 150 parts by weight (in particular, from 80 to 120 parts by weight).

The concentration of solutes in the liquid curable composition is approximately, for example, from 1 to 80 wt. %, preferably from 10 to 70 wt. %, and even more preferably from 20 to 60 wt. % (particularly, from 30 to 50 wt. %).

Examples of the coating method include typical methods including coater methods, such as the roll coater method, the air knife coater method, the blade coater method, the rod coater method, the reverse coater method, the bar coater method, the comma coater method, the dip squeeze coater method, the die coater method, the gravure coater method, the micro gravure coater method, and the silk screen coater method, as well as a dipping method, a spraying method, and a spinner method. Among these methods, the bar coater method or the gravure coater method are widely used. If necessary, the coating solution may be applied a plurality of times.

After the liquid curable composition has been cast or applied, the solvent may be removed by natural drying, but from the perspective of productivity, the liquid curable composition is preferably heated and dried. The heating temperature is approximately, for example, from 50 to 200° C., preferably from 60 to 150° C., and more preferably from 80 to 120° C.

The dried curable composition is cured by active light rays (such as ultraviolet light or an electron beam), heat, or the like, and depending on the type of the curable composition, heating, photoirradiation, and the like may be combined.

The heating temperature can be selected from an appropriate range, for example, from about 50 to 150° C. The photoirradiation can be selected according to the type of the photocuring component or the like, and usually, ultraviolet light, electron beams, and the like can be used. A commonly used light source is typically an ultraviolet irradiation device.

Examples of the light source in the case of ultraviolet light include a deep UV lamp, a low-pressure mercury lamp, a high-pressure mercury lamp, an ultrahigh-pressure mercury lamp, a halogen lamp, and a laser light source (light source such as a helium-cadmium laser or an excimer laser). The dose of irradiation light (irradiation energy) varies depending on the thickness of the coating film, and is approximately, for example, from 10 to 1000 mJ/cm², preferably from 20 to 500 mJ/cm², and more preferably from 30 to 300 mJ/cm². If necessary, the light irradiation may be performed in an inert gas atmosphere.

### Molded Article

The molded article according to an embodiment of the present invention contains the laminate, and the hard coat layer of the laminate is located on the surface of the molded article to express the hard coat function. Moreover, the shape and structure of the molded article are not particularly limited, and the hard coat layer has stretching characteristics, and thus the molded article is suitable for the use that requires bending. Therefore, the molded article according to an embodiment of the present invention may be a molded article having the laminate, with at least a portion of the laminate being curved or bent. Various shapes can be selected for the molded article according to the molding method. With in-mold molding such as in-mold lamination (IML), a two-dimensionally or three-dimensionally shaped molded article whose surface is covered with the laminate according to an embodiment of the present invention can be prepared through injection molding. With thermoforming (such as free blow molding, vacuum forming, folding, pressure forming, and matched-mold forming), the laminate according to an embodiment of the present invention can be further molded to prepare a molded article such as a container (sheet having a recess). With the laminate according to an embodiment of the present invention, a laminate that has good transparency can be easily prepared. Therefore, the laminate according to an embodiment of the present invention is particularly useful for in-mold molding, which is widely used in optical applications, ornamental (decorative) applications, and the like. In in-mold molding, ordinarily, while the laminate sheet according to an embodiment of the present invention is placed in a mold, a molten thermoplastic resin or an uncured curable resin (or a composition containing a curable resin) is molded and solidified by injection molding. And thus, the molded article according to an embodiment of the present invention can be obtained. In optical applications, various types of optical sheets that take advantage of transparency may be used, and in decorative applications, printing with a design property may be applied to the surface of the substrate layer on which the hard coat layer is not laminated, or a molded article (decorative molded article) integrated with the resin by in-mold molding on the printed surface side may be used.

### EXAMPLES

Hereinafter, the present invention is described in greater detail based on examples, but the present invention is not limited to these examples. The raw materials used in the examples and comparative examples are as indicated below, and the obtained laminates (hard coat films) were evaluated by the following method.

### Raw Material Designation

### Fluorine-Free Vinyl Compound

Urethane acrylate: “UA-1100H” available from Shin-Nakamura Chemical Co., Ltd.

Ethylene oxide (EO)-modified dipentaerythritol hexaacrylate: “A-DPH-12E” available from Shin-Nakamura Chemical Co., Ltd.

Nanosilica-containing alkoxylated pentaerythritol tetraacrylate: “NANOCRYL C165” available from Evonik Industries AG

Nanosilica-containing hexanediol diacrylate: “NANOCRYL C140” available from Evonik Industries AG

Silicone-containing acrylate: “KRM8479”, active component 80%; available from Daicel-Allnex Ltd.

### Fluorine-Containing Vinyl Compound

Fluorine-containing acrylate A: “Megafac RS-76-E” available from DIC Corporation, active component 40%

Fluorine-containing acrylate B: “PolyFox 3320” available from Omnova Solutions Inc., active component 100%.

### Thermoplastic Resin

Cellulose acetate propionate: “CAP-482-20”, available from Eastman Chemical Company, degree of acetylation=2.5%, degree of propionylation=46%, number average molecular weight calibrated with polystyrene=75000.

### Initiator

Photopolymerization initiator A: “Irgacure 907” available from BASF Japan Ltd.

Photopolymerization initiator B: “Irgacure 184” available from BASF Japan Ltd.

### Substrate Layer

PET film: “O321” available from Mitsubishi Chemical Corporation, thickness of 100 μm.

### Thickness of Hard Coat Layer

Ten arbitrary locations were measured using an optical film thickness gauge, and an average value was calculated.

### Tensile Elongation (Stretching Characteristics)

A test piece was fabricated by punching out a piece having a tensile No. 7 type dumbbell shape in accordance with JIS K6251, out of the obtained hard coat film. Using a tensile tester (Autograph AG-X, available from Shimadzu Corporation), the distance between the grips was set to 20 mm, the test piece was elongated at a tensile rate of 1 mm/min in an atmosphere with a temperature of 23° C. and a relative humidity of 50%, the maximum elongation (tensile elongation) of the test piece below which cracking did not occur in the hard coat layer was measured, and the elongation at that time was determined based on the following equation. Note that cracks generated in the hard coat layer were confirmed through visual observation.

(Elongation (%))=[((maximum elongation of test piece)−(distance between the grips))χ(distance between the grips))×100.

### Scratch Resistance

Using a steel wool durability tester equipped with a 1.0 cm diameter stick covered by steel wool #0000, the surface of the hard coat layer was rubbed with the steel wool sliding a distance of 5 cm and at a speed of 10 cm/s under a load of 1 kg/cm² at room temperature (20 to 25° C.) for 1000 reciprocating sliding motions. Then, the hard coat film was affixed to a black acrylic plate with a silicone-based transparent adhesive, and the appearance of the surface was observed under a fluorescent lamp equipped with a three-wavelength fluorescent tube and evaluated according to the following criteria.

A: No scratches

B: No linear scratches, but exhibits color change due to surface shavings.

C: Numerous linear scratches.

### Pencil Hardness

Pencil hardness was measured by the test method (750 g load) according to JIS K5600.

### Haze and Total Light Transmittance

Using a haze meter (“NDH5000W”, available from Nippon Denshoku Industries Co., Ltd.), the haze was measured according to the test method indicated in JIS K7136, and the total light transmittance was measured according to the test method indicated in JIS K7361.

### Water Contact Angle

Using an automatic dynamic contact angle meter (model DCA-UZ available from Kyowa Interface Science, Inc.), five measurements were done for the contact angle of approximately 3 μL of each liquid on the coating film and the results were averaged.

### Example 1

Forty parts by weight of urethane acrylate, 60 parts by weight of EO-modified dipentaerythritol hexaacrylate, 0.9 parts by weight of cellulose acetate propionate, 1.3 parts by weight of the fluorine-containing acrylate A, 1 part by weight of the photopolymerization initiator A, and 2 parts by weight of the photopolymerization initiator B were dissolved in a mixed solvent containing 135 parts by weight of methyl ethyl ketone, 29 parts by weight of 1-butanol, and 29 parts by weight of 1-methoxy-2-propanol propylene glycol monomethyl ether. This solution was casted onto a PET film using a wire bar #10, and then left in an oven at 100° C. for 1 minute to evaporate the solvent, and a coating layer having a thickness of approximately 5 μm was formed. The coating layer was then irradiated for approximately 5 seconds with UV light from a high-pressure mercury lamp (available from Eye Graphics Co., Ltd.) (amount of UV irradiation: 120 mJ/cm²), and a hard coat film (laminate) was produced.

### Example 2

A hard coat film was produced by the same method as Example 1, with the exception that the amount of urethane acrylate was changed to 80 parts by weight, and the amount of EO-modified dipentaerythritol hexaacrylate was changed to 20 parts by weight.

### Example 3

A hard coat film was produced by the same method as Example 1, with the exception that the amount of urethane acrylate was changed to 30 parts by weight, and the amount of EO-modified dipentaerythritol hexaacrylate was changed to 70 parts by weight.

### Example 4

A hard coat film was produced by the same method as Example 1, with the exception that the 1.3 parts by weight of the fluorine-containing acrylate A was changed to a mixture of 0.4 parts by weight of the fluorine-containing acrylate B and 0.2 parts by weight of the silicone-containing acrylate.

### Example 5

A hard coat film was produced by the same method as Example 1 with the exception that cellulose acetate propionate was not included.

### Example 6

A hard coat film was produced by the same method as Example 1 with the exception that the EO-modified dipentaerythritol hexaacrylate was changed to the nanosilica-containing alkoxylated pentaerythritol tetraacrylate.

### Example 7

A hard coat film was produced by the same method as Example 1 with the exception that the EO-modified dipentaerythritol hexaacrylate was changed to the nanosilca-containing hexanediol diacrylate.

### Comparative Example 1

A hard coat film was produced by the same method as Example 1 with the exception that 100 parts by weight of urethane acrylate, 0.9 parts by weight of cellulose acetate propionate, 1.3 parts by weight of the fluorine-containing acrylate A, 1 part by weight of the photopolymerization initiator A, and 2 parts by weight of the photopolymerization initiator B were dissolved in a mixed solvent containing 135 parts by weight of methyl ethyl ketone, 29 parts by weight of 1-butanol, and 29 parts by weight of 1-methoxy-2-propanol propylene glycol monomethyl ether.

### Comparative Example 2

A hard coat film was produced by the same method as Example 1 with the exception that 100 parts by weight of EO-modified dipentaerythritol hexaacrylate, 0.9 parts by weight of cellulose acetate propionate, 1 part by weight of the photopolymerization initiator A, and 2 parts by weight of the photopolymerization initiator B were dissolved in a mixed solvent containing 135 parts by weight of methyl ethyl ketone, 29 parts by weight of 1-butanol, and 29 parts by weight of 1-methoxy-2-propanol propylene glycol monomethyl ether.

Table 1 shows the evaluation results of the hard coat films obtained in the examples and comparative examples.

TABLE 1

| | | | | | | | | Compar- | |
|---|---|---|---|---|---|---|---|---|---|
| | | | | | | | | ative | |
| | Examples | | | | | | | Examples | |
| | 1 | 2 | 3 | 4 | 5 | 6 | 7 | 1 | 2 |
| Tensile | 8.9 | 5.4 | 9.2 | 8.8 | 8.7 | 7.1 | 6.0 | 4.4 | 15.0 |
| elongation | | | | | | | | | |
| (%) | | | | | | | | | |
| Scratch | A | A | A | A | A | B | B | A | C |
| resistance | | | | | | | | | |
| Pencil | H | 2H | H | H | H | 2H | H | 2H | B |
| hardness | | | | | | | | | |
| Haze (%) | 0.8 | 0.8 | 0.8 | 0.8 | 0.8 | 2.2 | 3.3 | 0.8 | 0.9 |
| Total light | 91 | 91 | 91 | 91 | 91 | 91 | 92 | 91 | 91 |
| trans- | | | | | | | | | |
| mittance | | | | | | | | | |
| (%) | | | | | | | | | |
| Water | 105 | 105 | 105 | 102 | 105 | 105 | 105 | 105 | 80 |
| contact | | | | | | | | | |
| angle (°) | | | | | | | | | |

As is clear from the results shown in Table 1, in the Examples, scratch resistance, hardness, and stretching characteristics (tensile elongation) were satisfied, whereas in the Comparative Examples, as the scratch resistance and hardness increased, stretching characteristics decreased, and as stretching characteristics increased, scratch resistance and hardness decreased. Furthermore, in Examples 1 to 3, despite the change in the ratio of the urethane acrylate and the EO-modified dipentaerythritol hexaacrylate, and the resulting change in elongation, the hard coat film maintained the same scratch resistance, and a pencil hardness of H or higher, which is required in the hard coat layer. Thus, the hard coat film exhibited a unique effect that contradicts the common observation that the hard coating property tends to decrease in association with an increase in stretching characteristics.

### INDUSTRIAL APPLICABILITY

The laminate of the present invention can be used in various molded articles molded by in-mold molding or thermoforming, and can be used, for example, in optical sheets and decorative molded articles and the like as molded articles molded by in-molding. An optical sheet that is molded by in-mold molding may be, for example, an optical sheet for a screen display device (such as, for example, car navigation displays, gaming devices, smartphones, tablet PCs, and other such displays and display devices with touch panels, PCs such as notebook or laptop type PCs and desktop PCs, and televisions). The decorative molded article formed by in-mold molding may be a housing for various types of devices (such as, for example, a display device for a screen, household or industrial electrical and electronic equipment, precision equipment, and automotive components), and the like. Examples of molded articles formed by thermoforming include packaging materials, various types of containers, trays, embossed tapes, carrier tapes, and magazines.

1. A laminate comprising a hard coat layer laminated on at least one surface of a substrate layer, wherein the laminate has a tensile elongation in accordance with JIS K6251 of 5% or greater, and exhibits no scratch after reciprocating sliding of a #0000 steel wool 1000 times on a surface of the hard coat layer under a load of 1 kg/cm².

2. The laminate according to claim 1, wherein a pencil hardness of the hard coat layer is F or higher.

3. The laminate according to claim 1, wherein a haze is 2% or less.

4. The laminate according to claim 1, wherein a total light transmittance is 85% or higher.

5. The laminate according to claim 1, wherein the hard coat layer is formed from a cured product of a curable composition including a fluorine-free vinyl compound, and the fluorine-free vinyl compound includes a polyfunctional (meth)acrylate.

6. The laminate according to claim 5, wherein the polyfunctional (meth)acrylate includes a urethane (meth)acrylate.

7. The laminate according to claim 6, wherein the urethane (meth)acrylate is a trifunctional or higher urethane (meth)acrylate having a weight average molecular weight of 3000 or less.

8. The laminate according to claim 5, wherein the polyfunctional (meth)acrylate includes a (meth)acrylate of a polyhydric alcohol-alkylene oxide adduct.

9. The laminate according to claim 8, wherein in the polyhydric alcohol-alkylene oxide adduct, the polyhydric alcohol is a trihydric or higher polyhydric alcohol, and a total number of moles of the alkylene oxide added is from 2 to 30 moles.

10. The laminate according to claim 8, wherein the polyhydric alcohol-alkylene oxide adduct is an adduct in which from 1 to 3 moles of ethylene oxide are added to each hydroxyl group of a tetrahydric to octahydric alcohol.

11. The laminate according to claim 5, wherein the curable composition further includes a fluorine-containing vinyl compound.

12. The laminate according to claim 11, wherein a weight ratio of the urethane (meth)acrylate to the (meth)acrylate of the polyhydric alcohol-alkylene oxide adduct, [the urethane (meth)acrylate]/[the (meth)acrylate of the polyhydric alcohol-alkylene oxide adduct], is from 80/20 to 30/70, and the ratio of the fluorine-containing vinyl compound is from 0.1 to 10 parts by weight per 100 parts by weight of the fluorine-free vinyl compound.

13. A molded article comprising the laminate described in claim 1.

14. The molded article according to claim 13, wherein at least a portion of the laminate is curved or bent.

15. A method for producing a molded article by molding the laminate described in claim 1.

16. The method according to claim 15, wherein the molding is in-mold molding.
